(19) United States
(12) Patent Application Publication
(10) Pub. No.: US 2026/0082016 A1
(43) Pub. Date: Mar. 19, 2026

(54) PRIVATE AUDIO TRANSMISSION IN VIRTUAL MEETINGS USING ARTIFICIAL INTELLIGENCE (AI)

(71) Applicant: Google LLC, Mountain View, CA (US)

(72) Inventor: Stefan Lindmark, Östhammar (SE)

(21) Appl. No.: 18/887,600

(22) Filed: Sep. 17, 2024

(51) Int. Cl. H04N 7/15; G10L 15/26; G10L 21/003; H04N 7/14

(52) U.S. Cl. CPC H04N 7/152; G10L 15/26; G10L 21/003; H04N 7/147; H04N 7/157

(57) ABSTRACT

A system and method for private audio transmission in virtual meetings using artificial intelligence (AI), the operations including obtaining distorted audio data captured at a client device of a first participant of a plurality of participants of a virtual meeting, wherein the distorted audio data is associated with a distorted tone of voice of the first participant; generating, using a first trained artificial intelligence (AI) model, modified audio data that corresponds to the distorted audio data and is associated with a modified tone of voice of the first participant, the modified tone of voice reflecting one or more modifications to the distorted tone of voice; and causing the modified audio data to represent speech of the first participant during a first portion of the virtual meeting between the plurality of participants.

### TECHNICAL FIELD

Aspects and implementations of the present disclosure relate to private audio transmission in virtual meetings using artificial intelligence (AI).

### BACKGROUND

Virtual meeting participants can join a virtual meeting from most locations where a computing device can connect to a network. A participant may desire to conduct a private, or semi-private communication in a virtual meeting in a public or semi-public location.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

An aspect of the disclosure provides a computer-implemented method including: obtaining distorted audio data captured at a client device of a first participant of a plurality of participants of a virtual meeting, wherein the distorted audio data is associated with a distorted tone of voice of the first participant; generating, using a first trained artificial intelligence (AI) model, modified audio data that corresponds to the distorted audio data and is associated with a modified tone of voice of the first participant, the modified tone of voice reflecting one or more modifications to the distorted tone of voice; and causing the modified audio data to represent speech of the first participant during a first portion of the virtual meeting between the plurality of participants.

In some aspects, the distorted tone of voice is associated with first voice data of the first participant, the method further comprising: removing, using a second trained AI model, (i) non-voice data and (ii) non-participant voice data from the distorted audio data, wherein the second trained AI model is trained on training voice data of the first participant to extract the first voice data of the first participant from the distorted audio data.

In some aspects, the method further comprising: adding, to the modified audio data generated by the first AI model, (i) the non-voice data of the distorted audio data and (ii) the non-participant voice data of the distorted audio data.

In some aspects, the distorted tone of voice comprises one or more of a volume characteristic, an intonation characteristic, an articulation characteristic, a speed characteristic, or a pronunciation characteristic.

In some aspects, the method further comprising: determining, using the first trained AI model, a level of confidence that the modified tone of voice matches a regular tone of voice of the first participant; and causing a confidence indicator to be displayed to the first participant via a graphical user interface (GUI) of the client device, the confidence indicator being based on the determined level of confidence.

In some aspects, the method further comprising: receiving, through a graphical user interface (GUI) of the client device, user input to request that the distorted audio data represent speech of the first participant during a second portion of the virtual meeting; and responsive to receiving the user input, causing the distorted audio data to represent the speech of the first participant during the second portion of the virtual meeting.

In some aspects, the method further comprising: generating a first text transcript of the distorted audio data; generating a second text transcript of the modified audio data; and generating, based on the first text transcript and the second text transcript, a first participant text transcript for the first participant.

In some aspects, the method further comprising: causing a visual element to be displayed to the plurality of participants via respective graphical user interfaces (GUIs) of respective client devices associated with each participant, the visual element indicating that the speech of the first participant during the first portion of the virtual meeting is modified audio data generated by an AI model.

An aspect of the disclosure provide a computer-implemented method comprising: generating first training data for training an artificial intelligence (AI) model, wherein generating the first training data comprises: generating a first training input, the first training input comprising first training audio data associated with a suppressed tone of voice of a first participant; generating a second training input, the second training input comprising second training audio data associated with a dynamic tone of voice of the first participant; and providing the first training data to train the AI model on a set of training inputs comprising (i) the first training input and (ii) the second training input to generate a first training output that indicates, for a given audio data associated with a suppressed tone of voice of a respective participant, a first modified audio data associated with a first restored tone of voice of the respective participant.

In some aspects, the first modified audio data reflects a transformation for one or more characteristics of the suppressed tone of voice of the respective participant.

In some aspects, the one or more characteristics of the suppressed tone of voice comprise at least one of a volume characteristic, an intonation characteristic, an articulation characteristic, a speed characteristic, or a pronunciation characteristic.

In some aspects, the method further comprising: generating second training data for training the AI model, wherein generating the second training data comprises: prompting the respective participant to provide distorted audio data with the suppressed tone of voice of the respective participant; prompting the respective participant to provide modified audio data with a regular tone of voice of the respective participant; generating a third training input comprising the distorted audio data; generating a fourth training input comprising the modified audio data, wherein the second training data comprises the third training data and the fourth training data; and providing the second training data to train the AI model to generate a second training output that indicates, for a received audio data associated with the suppressed tone of voice of the respective participant, a second modified audio data associated with a second restored tone of voice of the respective participant.

In some aspects, the AI model is further to generate a second training output that indicates a level of confidence that the second restored tone of voice matches the regular tone of voice of the respective participant.

An aspect of the disclosure provides a system including a memory and one or more processing devices communicatively coupled to the memory, the one or more processing devices to: obtain distorted audio data captured at a client device of a first participant of a plurality of participants of a virtual meeting, wherein the distorted audio data is associated with a distorted tone of voice of the first participant; generate, using a first trained artificial intelligence (AI) model, modified audio data that corresponds to the distorted audio data and is associated with a modified tone of voice of the first participant, the modified tone of voice reflecting one or more modifications to the distorted tone of voice; and cause the modified audio data to represent speech of the first participant during a first portion of the virtual meeting between the plurality of participants.

In some aspects, the distorted tone of voice is associated with first voice data of the first participant, the one or more processing devices further to: remove, using a second trained AI model, (i) non-voice data and (ii) non-participant voice data from the distorted audio data, wherein the second trained AI model is trained on training voice data of the first participant to extract the first voice data of the first participant from the distorted audio data.

In some aspects, the one or more processing devices further to: add, to the modified audio data generated by the first AI model, (i) the non-voice data of the distorted audio data and (ii) the non-participant voice data of the distorted audio data.

In some aspects, the distorted tone of voice comprises one or more of a volume characteristic, an intonation characteristic, an articulation characteristic, a speed characteristic, or a pronunciation characteristic.

In some aspects, the one or more processing devices further to: determine, using the first trained AI model, a level of confidence that the modified tone of voice matches a regular tone of voice of the first participant; and cause a confidence indicator to be displayed to the first participant via a graphical user interface (GUI) of the client device, the confidence indicator being based on the determined level of confidence.

In some aspects, the one or more processing devices further to: receive, through a graphical user interface (GUI) of the client device, user input to request that the distorted audio data represent speech of the first participant during a second portion of the virtual meeting; and responsive to receiving the user input, cause the distorted audio data to represent the speech of the first participant during the second portion of the virtual meeting.

In some aspects, the one or more processing devices further to: generate a first text transcript of the distorted audio data; generate a second text transcript of the modified audio data; and generate, based on the first text transcript and the second text transcript, a first participant text transcript for the first participant.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system architecture, according to aspects of the disclosure.

FIG. 2 is an example block diagram of using a private audio module to generate outputs based on various inputs, according to some aspects of the disclosure.

FIG. 3 is a block diagram that illustrates the inputs and outputs for AI models of a private audio module of the virtual meeting platform, according to some aspects of the disclosure.

FIG. 4 is an example block diagram of using a training engine to generate training outputs based on various training inputs, according to some aspects of the disclosure.

FIG. 5 is a flow diagram of an example method for private audio transmission in virtual meetings using AI, according to some aspects of the disclosure.

FIG. 6 is a flow diagram of an example method for private audio transmission in virtual meetings using AI, according to some aspects of the disclosure.

FIG. 7 is a flow diagram of an example method for private audio transmission in virtual meetings using AI, according to some aspects of the disclosure.

FIG. 8 is a block diagram illustrating an example of a computer system, according to aspects of the disclosure.

### DETAILED DESCRIPTION

Aspects of the present disclosure relate to private audio transmission in virtual meetings using artificial intelligence (AI). A virtual meeting can refer to a meeting that is attended by participants using respective client devices connected to a virtual meeting platform. A client device connected to the virtual meeting platform captures and transmits image data (e.g., collected by a camera of the client device) and/or audio data (e.g., collected by a microphone of the client device) to other client devices connected to the virtual meeting platform. The image data may depict a user (e.g., a participant) or a group of users that are participating in the virtual meeting. The audio data may include an audio recording of audio provided by the user or group of users during the virtual meeting. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to ten-thousand or more client devices) to be connected via the virtual meeting.

Maintaining communication privacy in a virtual meeting can be challenging, especially for a participant that connects to the virtual meeting in a public or semi-public environment. Some communication privacy can be maintained with external tools. For example, a privacy screen or similar can be used to prevent bystanders from viewing a participant's screen. In another example, headphones or similar can be used to isolate incoming audio communication from the virtual meeting. However, the participant will often still need to speak in the virtual meeting. Their speech, especially in a regular tone of voice, may be overheard by bystanders. To mitigate this, the participant may attempt to speak quietly; however, it is still possible for the participant to be overheard, and participants of the virtual meeting may have difficulty understanding the quietly speaking participant, especially if there is a lot of background noise or voices of non-participants.

Aspects of the present disclosure address these and other challenges by providing private audio transmission in virtual meetings using artificial intelligence (AI). Audio data is captured from the user (e.g., using a built-in or external microphone). A first AI model is trained to identify the voice of the participant. In particular, the first AI model is trained to identify characteristics of a tone of voice of the participant. The first AI model can be trained on high-quality, low-noise recordings of the participant's voice that are captured in a controlled (e.g., low-noise) environment. A second AI model is a voice restoration model that transforms a distorted voice of the participant to a restored voice of the participant, which may sound similar to a regular voice of the participant (e.g., a non-distorted voice of the participant). The second AI model can use the characteristics of the tone of voice of the participant identified by the first model to generate the restored voice of the participant. The second AI model can be trained using audio obtained from the participant in a controlled (e.g., low-noise) environment. The restored voice of the participant can be used in place of the recorded voice of the participant (e.g., the distorted voice) during the virtual meeting.

As used herein, “tone of voice” refers to measurable auditory characteristics of a participant's speech. Such auditory characteristics can include, for example, one or more of a volume of speech, an intonation of speech, an articulation of speech, a speed of speech, a pronunciation of speech, or the like.

As used herein, “volume” of speech refers to a loudness or intensity of a participant's voice, and can be a measure of how forcefully air passes by the vocal cords of the participant.

As used herein, “intonation” of speech refers to a variation in pitch or melody of the participant's voice, and can represent conveyed emotions, emphasis, or parts of speech. For example, a rising intonation at the end of a sentence can indicate a question, while a falling intonation can indicate a statement or conclusion.

As used herein, “articulation” of speech refers to the clarity and precision with which a participant makes speech sounds, such as consonant or vowel sounds. Articulation of speech can be based on the movement and coordination of the tongue, lips, jaw, and other speech organs to form distinct phonetic sounds.

As used herein, “speed” of speech refers to a speech rate, or pace at which a participant speaks. The speed can refer to how fast the participant combines sounds in a word to speak the word (e.g., how fast the word is spoken) and/or how fast the participant combines words to form their speech (e.g., the length of pauses in between words), and may be measured in spoken words per minute (WPM).

As used herein, “pronunciation” of speech refers to particular sounds made by the individual participant when speaking a particular word or phoneme. Pronunciation of speech can be based on an accents of a language. For example, a participant with a British accent will pronounce words differently than a participant with an American accent, despite both attempting to speak the same English word or phrase. Pronunciation of speech can also be based on specific sounds produced by the individual when speaking a word or phoneme. For example, a participant with a lisp will pronounce words differently than a participant without a lisp.

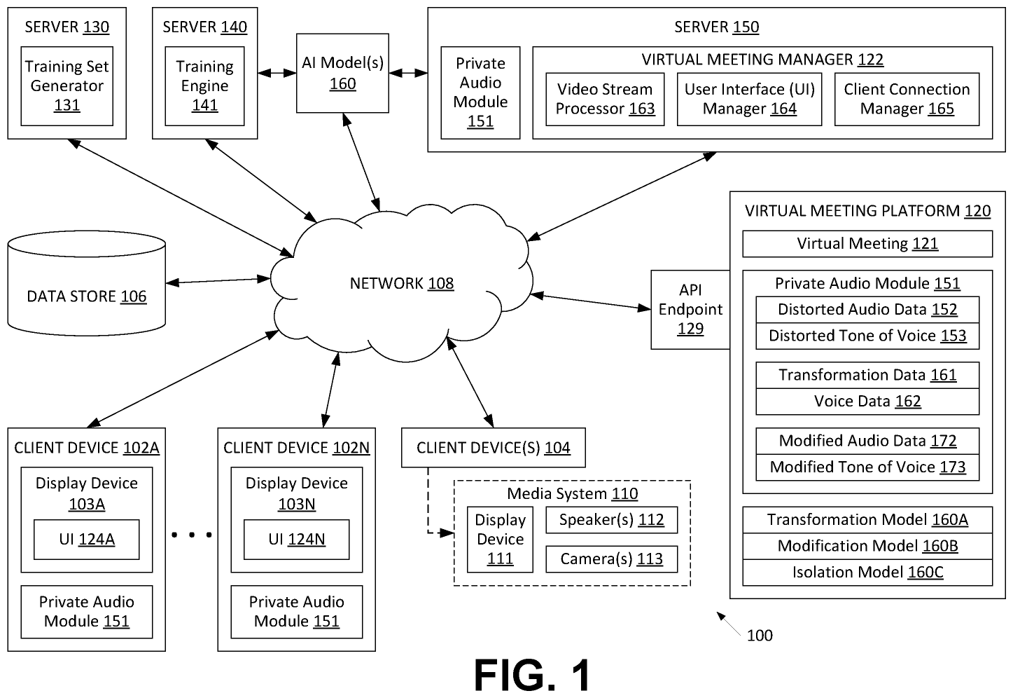

Modifications to a tone of voice can of the participant refer to changes made to any of the above (or other) auditory characteristics of the participant's speech. Modifications to the tone of voice may be performed by the participant, such as when the participant speaks in a whispered voice or hushed voice. Modifications to the tone of voice may also be performed by a private audio module or AI model, as described above. Additional details regarding tone of voice and modifications to the tone of voice are described below with reference to FIGS. 1-3.

As used herein a “regular voice” refers to a means of vocal communication where the person speaks at a normal volume using normal breaths to fully engage their vocal cords. When using a regular voice, the person's vocal cords vibrate more fully as more air passes through them, which in turn creates a louder, clearer sound that can be heard over a greater distance (in comparison to the whispered voice). The regular voice is associated with a regular tone of voice (i.e., a tone of voice without modifications).

As used herein, a “distorted” voice can refer to a means of vocal communication where a person modifies their means of vocal communication from their regular voice. The alteration can be intentional, or unintentional. An example of a distorted voice is a whispered voice, where the person speaks softly by using a small breath, without fully engaging their vocal cords. The result is a quiet sound that is often only heard at short distances. The lips and mouth still form the words, but the volume is much lower than a regular voice of the person. Other modifications to vocal communication may include, for example, a shouted voice, a pitch-shifted voice, or the like.

As used herein, a “restored voice” or “target voice” refers to a means of vocal communication that is computer-generated, such as by using a private audio module or AI model. In some implementations, the restored voice that is generated will not be an exact match to a regular voice of the participant. However, the restored voice is intended to match as closely as possible to the regular voice of the participant. In some implementations, a restored voice is an example of a transformation of, or modification to a distorted voice. The restored voice can be generated by a computing element, such as a private audio module or AI model. The restored voice can be associated with a modified or target tone of voice. In some implementations, the restored voice will not In some implementations, as is further described below, the restored voice can be generated based on a modified tone of voice.

As used herein, a “suppressed tone of voice” refers to a means of vocal communication where auditory characteristics such as volume, intensity, or pitch, of a person's voice are limited. Often a participant may use a suppressed tone of voice to reduce the volume of their speech, or convey a specific emotion, such as discretion or restraint. The characteristics of a suppressed tone of voice often have minimal variation. For example, a monotone voice where the pitch of the voice does not change substantially can be referred to as a suppressed tone of voice. Often, a suppressed tone of voice is associated with a whispered voice, described above.

As used herein, a “dynamic tone of voice” refers to a means of vocal communication where auditory characteristics such as volume, intensity, or pitch of a person's voice are not limited. Often a participant's regular voice may naturally vary based on the words, ideas, emotions, or the like that the person intends to convey in their vocal communication. In contrast to the suppressed tone of voice, the characteristics of a dynamic tone of voice may (but do not necessarily) have more variation. For example, the dynamic tone of a person who is nervous may have an altered volume, intensity, or pitch, especially in response to an external stimulus. Often, a dynamic tone of voice is associated with a regular voice, described above.

Advantages of providing for private audio transmission in virtual meetings using artificial intelligence (AI) include improved audio communications in virtual meetings, and improved privacy of virtual meeting communications (especially in public or semi-public environments). Additionally, participants of the virtual meeting can have a more natural or pleasant experience with the participant who is using a whispered voice, as the voice that the participants hear and engage with is a representation of the participant's regular voice.

FIG. 1 illustrates an example of a system 100, according to some aspects of the disclosure. The system 100 includes client devices 102A-102N, one or more client device(s) 104, a data store 106, a virtual meeting platform 120, and a server 130, each connected to a network 108.

In implementations, network 108 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data store 106 is a persistent storage that is capable of storing data as well as data structures to tag, organize, and index the data. In some implementations, data can include one or more of structured data, unstructured data, vectorized data, etc., or types of digital files, including text data, audio data, image data, video data, multimedia, interactive media, data objects, and/or any suitable type of digital resource, among other types of data. An example of data stored at the data store 106 can include a file, database record, database entry, programming code or document, among others. The data store 106 can be hosted by one or more storage devices, such as main memory, magnetic or optical storage based disks, tapes or hard drives, network-attached storage (NAS), storage area network (SAN), and so forth. In some implementations, the data store 106 can be a network-attached file server, while in other implementations the data store 106 can be another type of persistent storage such as an object-oriented database, a relational database, and so forth, that can be hosted by virtual meeting platform 120, or one or more different machines coupled to the server hosting the virtual meeting platform 120 via the network 108.

Virtual meeting platform 120 can enable users of client devices 102A-102N and/or client device(s) 104 to connect with each other via a virtual meeting (e.g., a virtual meeting 121). A virtual meeting 121 refers to a real-time communication session such as a virtual meeting call, also known as a video-based call or video chat, in which participants can connect with multiple additional participants in real-time and be provided with audio and/or video capabilities. Real-time communication refers to the ability for participants to communicate (e.g., exchange information) instantly without transmission delays and/or with negligible (e.g., milliseconds or microseconds) latency. Virtual meeting platform 120 can allow a user (e.g., a participant of the virtual meeting) to join and participate in a virtual meeting 121 with other users of the platform (e.g., other participants of the virtual meeting). Implementations of the present disclosure can be implemented with any number of participants connecting via the virtual meeting 121.

The virtual meeting platform 120 can include a private audio module 151. The private audio module 151 can also be included in one or more of client devices 102A-102N, or server 150 (as illustrated), as well as other elements of system 100 (not illustrated). The private audio module 151 includes distorted audio data 152 associated with a distorted tone of voice 153, and modified audio data 172 associated with a modified tone of voice 173.

During a virtual meeting 121, the private audio module 151 receives distorted audio data 152 as input, and produces modified audio data 172 as output. In some implementations, the private audio module 151 uses transformation data 161 to produce the modified audio data 172 from the distorted audio data 152. In some implementations, the private audio module 151 can use one or more AI model(s) 160 to produce the modified audio data 172 from the distorted audio data 152.

In some implementations, the private audio module 151 generates the transformation data 161 using an AI model 160 (e.g., transformation AI model 160A). The private audio module 151 can provide voice data 162 as input to the transformation AI model 160A. The transformation AI model 160A can generate transformation data 161 as an output. In some implementations, the transformation data 161 generated by the transformation AI model 160A can include information representing one or more modifications to be performed to the distorted voice data to produce a restored voice that reflects the regular voice of the participant. For example, the transformation data 161 can represent parameters for an AI model 160 that generates the restored voice data as an output from an input of distorted voice data (e.g., the restoration AI model 160B).

In alternative implementations, the transformation data 161 generated by the transformation AI model 160A includes information representing one or more modifications to be performed to auditory characteristics of a distorted tone of voice 153 reflected in the distorted voice data to produce modified auditory characteristics of a modified tone of voice 173 that represent auditory characteristics of the regular voice of the participant. For example, the transformation data 161 can include information representing parameters for an AI model 160 that generates a modified tone of voice 173 as an output from an input of a distorted tone of voice 153 (e.g., the modification AI model 160B).

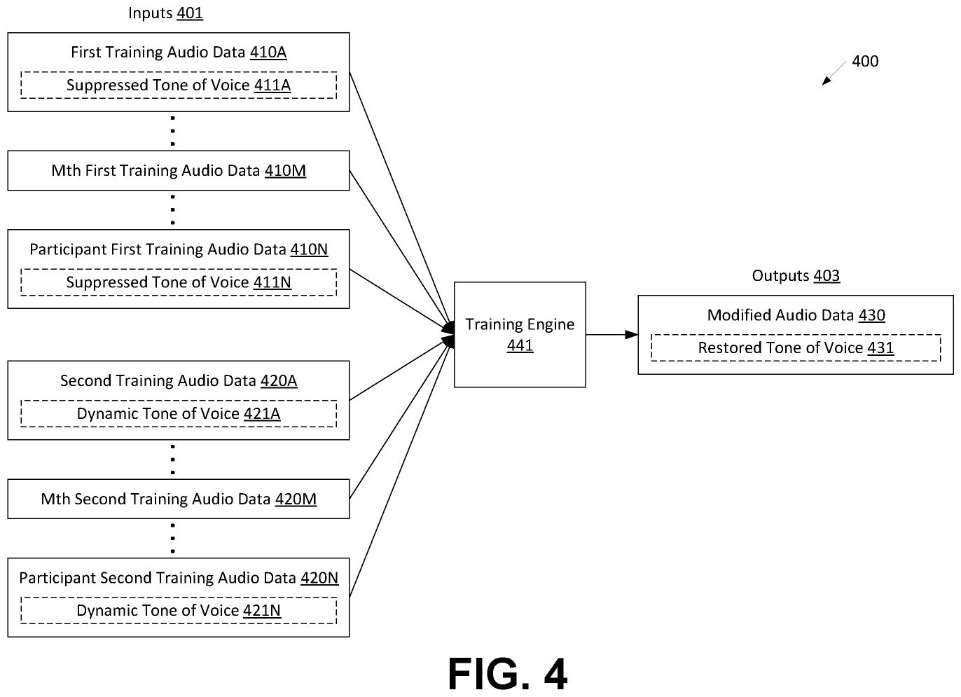

In some implementations, the transformation AI model 160A is trained on participant voice data captured by a client device 102A-102N in a controlled (e.g., noise-free) environment. In some implementations, the participant voice data used to train the transformation AI model 160A includes participant voice data having a distorted tone of voice and participant voice data having a regular tone of voice. For example, the private audio module 151 of the virtual meeting platform 120 can prompt a participant to provide audio data through one or more of client devices 102A-102N. In some implementations, the private audio module 151 can prompt the participant to provide voice data associated with a suppressed tone of voice (e.g., by speaking in a whispered voice or a hushed voice). In some implementations, the private audio module 151 can prompt the participant to provide voice data associated with a dynamic tone of voice (e.g., by speaking in a regular voice). Additional details regarding using the private audio module to generate modified audio data are described below with reference to FIGS. 4-6.

In some implementations, the transformation AI model 160A is trained on training inputs to generate target outputs (e.g., supervised, or partially-supervised learning). The training inputs can include participant voice data having a distorted tone of voice, and the target outputs can include participant voice data having a regular tone of voice (as captured by a client device 102A-102N). In alternative implementations, the transformation AI model 160A is trained on specific training inputs to generate training outputs (e.g., unsupervised, or partially-unsupervised learning). The training inputs can include participant voice data having a distorted tone of voice and participant voice data having a regular tone of voice (as captured by a client device 102A-102N).

The modification AI model 160B can be trained to modify the voice data in distorted audio data 152 to produce modified voice data in modified audio data 172. In some implementations, the modification AI model 160B receives distorted audio data 152 reflecting a distorted tone of voice 153 as input. The modification AI model 160B generates an output of modified audio data 172 reflecting a modified tone of voice 173. In some implementations, the modification AI model 160B receives indications of one or more auditory characteristics of the distorted tone of voice 153 and generates one or more modified auditory characteristics for the modified tone of voice 173.

The private audio module 151 can generate modified audio data 172 from the output of the modification AI model 160B. In some implementations, representations of audio data that was removed from the distorted audio data 152 can be re-added to modified audio data reflecting a modified tone of voice to produce the modified audio data 172. In some implementations, the modified audio data 172 includes modified voice data reflecting the modified tone of voice 173.

In some implementations, the private audio module 151 can use an AI model 160 to remove background noise and non-participant voices from distorted audio data (e.g., isolation AI model 160C). The resulting audio can be participant voice data having a distorted tone of voice 153. In alternative implementations, the isolation AI model 160C can extract participant voice data from the distorted audio data 152. The extracted participant voice data will have a distorted tone of voice 153. In some implementations, the private audio module 151 uses the participant voice data as input to the transformation AI model 160A to generate transformation data 161. In some implementations, the private audio module 151 uses the distorted tone of voice 153 of the participant voice data as input to the transformation AI model 160A to generate transformation data 161.

In some implementations, the isolation AI model 160C can be trained using participant voice data obtained for training the transformation AI model 160A. For example, the isolation AI model 160C can be trained to identify and remove or suppress non-participant voice data that is present in audio data captured by a client device 102A-102N. In some implementations, representations of audio data removed by the isolation AI model 160C can be used by the private audio module 151 to generate the modified audio data 172.

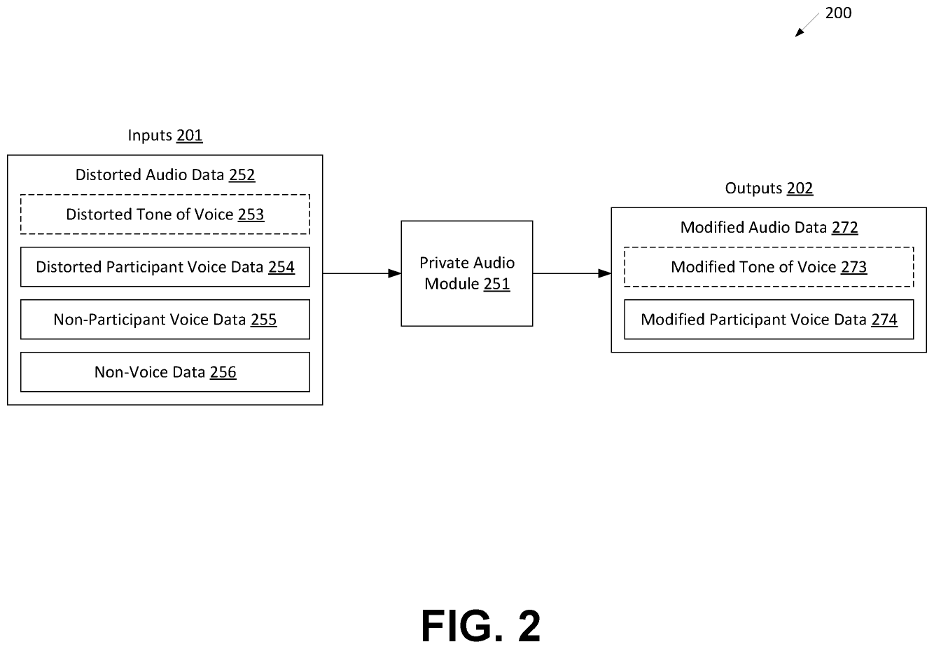

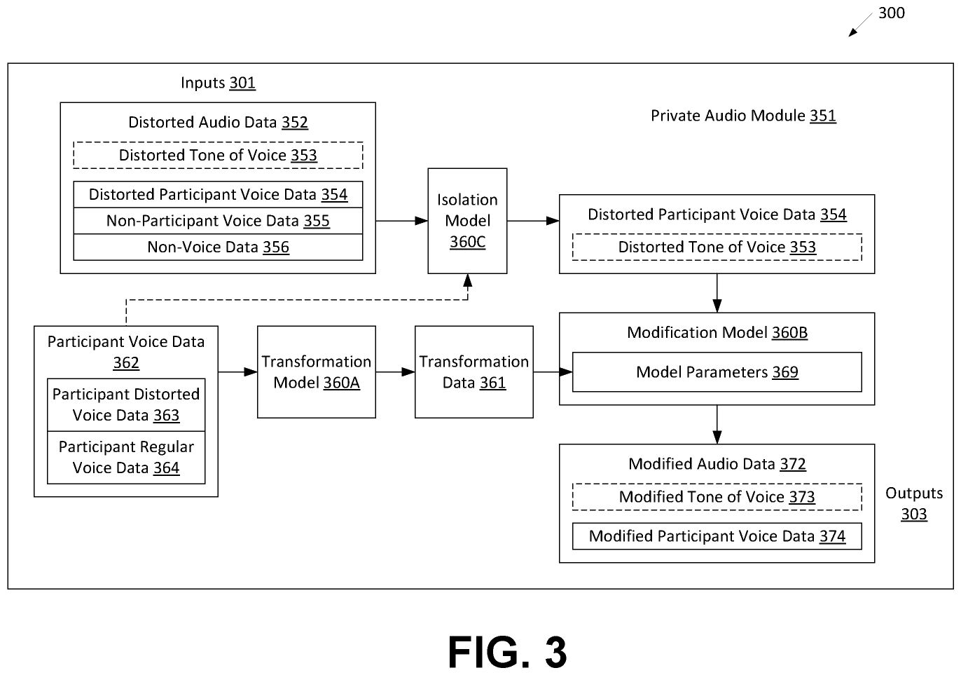

For example, the distorted audio data 152 may contain first participant voice data in addition to audio data (e.g., non-participant voice data, background sounds, etc.) that is relevant to the communication captured by a client device 102A-102N. The first participant voice data may be distorted (e.g., distorted participant voice data). After the modified audio data is generated having the modified participant voice data, representations of previously removed audio data (e.g., audio data removed from the distorted audio data 152) can be added back into the modified audio data 172. In this way, the modified audio data 172 can improve the representation of the participant's voice while maintaining the other audio data present in the distorted audio data 152. In some implementations, this can be used, for example, to rebalance the volume or other auditory characteristics of the participant voice data in comparison to auditory characteristics of other audio data (e.g., non-participant voice data, and non-voice data) in the distorted audio data 152. Additional details regarding the distorted audio data 152, distorted tone of voice 153, modified audio data 172 and modified tone of voice 173 are described below with reference to FIGS. 2-3.

The client devices 102A-102N can each include computing devices such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, client devices 102A-102N can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, client devices 102A-102N can also be referred to as “user devices. ” Each client device 102A-102N can include an audiovisual component that can generate audio and video data to be streamed to virtual meeting platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user (e.g., a virtual meeting participant) associated with a particular client device. In some implementations, the audiovisual component can also include an image capture device (e.g., a camera) to capture images and generate video data (e.g., a video stream) of the captured data of the captured images.

In some implementations, the client devices 102A-102N can implement or include one or more applications to communicate (e.g., send and receive information) with the virtual meeting platform 120. In some implementations, the client devices 102A-102N can implement a user interface (UI) (e.g., graphical user interfaces (GUIs)), such as a UI 124A-124N) that may be webpages rendered by a web browser and displayed on the client devices 102A-102N in a web browser window. In another embodiment, the UI 124A-124N of the client devices 102A-102N may be included in a stand-alone application downloaded to the client devices 102A-102N and natively running on the client devices 102A-102N (also referred to as a “native application” or “native client application” herein). In some implementations, some or all portions of the private audio module 151 can be implemented at the client device 102A-102N.

In some implementations, the virtual meeting platform 120 is coupled, via network 108, with one or more client device(s) 104 that are each associated with a physical conference or meeting room. Client device(s) 104 can include or be coupled to a media system 110 that can include one or more display devices 111, one or more speaker(s) 112 and one or more camera(s) 113. Display device 111 can be, for example, a smart display or a non-smart display (e.g., a display that is not itself configured to connect to network 108). Users that are physically present in the room can use the media system 110 rather than their own devices (e.g., client devices 102A-102N) to participate in virtual meeting 121, which can include other remote users. For example, the users in the room that participate in the virtual meeting can control the display device 111 to show a slide presentation or watch slide presentations of other participants. Sound and/or camera control can similarly be performed. Similar to client devices 102A-102N, client device(s) 104 can generate audio and video data to be streamed to virtual meeting platform 120 (e.g., using one or more microphones, speaker(s) 112 and camera(s) 113).

Each client device 102A-102N or client device(s) 104 can include a browser and/or a client application (e.g., a mobile application, a desktop application, etc.). In some implementations, the web browser and/or the client application can present, on a display device 103A-103N of client device 102A-102N, a user interface (UI) (e.g., a UI of the UIs 124A-124N) for users to access the virtual meeting platform 120. For example, a user of client device 102A can join and participate in a virtual meeting via a UI 124A presented on the display device 103A by the web browser or client application. A user can also present a document to participants of the virtual meeting via each of the UIs 124A-124N. Each of the UIs 124A-124N can include multiple regions to present video streams corresponding to video streams of the client devices 102A-102N provided to the server 130 for the virtual meeting. In some implementations, the UIs 124A-124N may include various visual elements (e.g., UI elements) and regions, and can be a mechanism by which the user engages with the virtual meeting platform 120, and system 100 at large. In some implementations, the UIs 124A-124N of the client devices 102A-102N can include multiple visual elements and regions that enable presentation of information, for decision-making, content delivery, etc. at the client devices 102A-102N. In some implementations, the UIs 124A-124N may sometimes be referred to as a graphical user interface (GUI)).

In some implementations, the UIs 124A-124N and/or client devices 102A-102N can include input features to intake information from a client devices 102A-102N. In one or more examples, a user of client devices 102A-102N can provide input data (e.g., a user query, control commands, etc.) into an input feature of the UIs 124A-124N or client devices 102A-102N, for transmission to the virtual meeting platform 120, and system 100 at large. Input features of UIs 124A-124N and/or client devices 102A-102N can include space, regions, or elements of the UIs 124A-124N that accept user inputs. For example, input features may include visual elements (e.g., GUI elements) such as buttons, text-entry spaces, selection lists, drop-down lists, etc. For example, in some implementations, input features may include a chat box which a user of client devices 102A-102N can use to input textual data (e.g., a user query). The client devices 102A-102N can then transmit that textual data to virtual meeting platform 120, and the system 100 at large, for further processing. In other examples, input features can include a selection list, in which a user of client devices 102A-102N can input selection data e.g., by selecting, or clicking. The client devices 102A-102N can then transmit that selection data to virtual meeting platform 120, and the system 100 at large, for further processing.

In some implementations, server 130 can include a virtual meeting manager 122. Virtual meeting manager 122 is configured to manage a virtual meeting between multiple users of virtual meeting platform 120. In some implementations, the virtual meeting manager 122 can provide the UIs 124A-124N to each client device to enable users to watch and listen to each other during a virtual meeting. Virtual meeting manager 122 can also collect and provide data associated with the virtual meeting to each participant of virtual meeting 121. In some implementations, virtual meeting manager 122 can provide the UIs 124A-124N for presentation by a client application (e.g., a mobile application, a desktop application, etc.). For example, the UIs 124A-124N can be displayed on a display device 103A-103N by a native application executing on the operating system of the client device 120A-120N or the client device(s) 104. The native application can be separate from a web browser. In some implementations, the virtual meeting manager 122 can determine visual items for presentation in the UI 124A-124N during a virtual meeting. A visual item can refer to a UI element that occupies a particular region in the UI and is dedicated to presenting a video stream from a respective client device. Such a video stream can depict, for example, a user of the respective client device while the user is participating in the virtual meeting (e.g., speaking, presenting, listening to other participants, watching other participants, etc., at particular moments during the virtual meeting), a physical conference or meeting room (e.g., with one or more participants present), a document or other media content (e.g., video content, one or more images, etc.) being presented during the virtual meeting, and the like. It is appreciated that providing video streams for presentation is described herein by way of example, and not limitations, noting that aspects and implementations of the present disclosure can be applied to other visual items (e.g., recorded videos) without deviating from the scope of the present disclosure.

In some implementations, the virtual meeting manager 122 includes a video stream processor 163, a user interface (UI) manager 164, and a client connection manager 165. The components can be combined together or separated into further components, according to a particular implementation. It should be noted that in some implementations, various components of the virtual meeting manager 122 can run on separate machines.

The video stream processor 163 can receive video streams from client devices 102A-102N and/or client device(s) 104. The video stream processor 163 can determine video streams for presentation in the UIs 124A-124N during the virtual meeting 121. Each video stream can correspond to a video stream from a client device (e.g., the video stream pertaining to one or more participants of the virtual meeting). In some implementations, the video stream processor 163 can receive audio streams associated with the video streams from the client devices (e.g., from an audiovisual component of the client devices 102A-102N).

The User Interface (UI) manager 164 can provide a UI for a virtual meeting. The UI can include multiple regions. Each region can display a video stream pertaining to one or more participants of the virtual meeting. The UI manager 164 can control which video stream is to be displayed by providing a command to the client devices that indicates which video stream is to be displayed in which region of the UI (along with the received video and audio streams being provided to the client devices). For example, in response to being notified of the determined video streams for presentation in the UI 124A-124N, the UI manager 164 can transmit a command causing each determined video streams to be displayed in a region of the UI and/or rearranged in the UI.

A participant can join and participate in a virtual meeting via a UI 124A presented on the display device 103A by the web browser or client application. As described previously, an audiovisual component of each client device can capture images and generate video data (e.g., a video stream) of the captured data of the captured images. In some implementations, the client devices 102A-102N and/or client device(s) 104 can transmit the generated video stream to virtual meeting manager 122. The audiovisual component of each client device can also capture an audio signal representing speech of a user and generate audio data (e.g., an audio file or audio stream) based on the captured audio signal. In some implementations, the client devices 102A-102N and/or client device(s) 104 can transmit the generated audio data to virtual meeting manager 122.

In some implementations, a client device 102A can access the virtual meeting platform 120 through network 108 using one or more application programming interface (API) calls via platform API endpoint 129. In some implementations, virtual meeting platform 120 can include multiple platform API endpoints 129 that can expose services, functionality, or information of the virtual meeting platform 120 to one or more client devices 102A-102N. In some implementations, a platform API endpoint 129 can be one end of a communication channel, where the other end can be another system, such as a client device 102A associated with a participant or user account. In some implementations, the platform API endpoint 129 can include or be accessed using a resource locator, such a universal resource identifier (URI), universal resource locator (URL), of a server or service. The platform API endpoint 129 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 129.

In some implementations, the platform API endpoint 129 can function as a computer interface through which access requests are received and/or created. In some implementations, the platform API endpoint 129 can include a platform API whereby external entities or systems can request access to services and/or information provided by the virtual meeting platform 120. The platform API can be used to programmatically obtain services and/or information associated with a request for services and/or information.

In some implementations, the API of the platform API endpoint 129 can be any suitable type of API such as a REST (Representational State Transfer) API, a GraphQL API, a SOAP (Simple Object Access Protocol) API, and/or any suitable type of API. In some implementations, the virtual meeting platform 120 can expose through the API, a set of API resources which when addressed can be used for requesting different actions, inspecting state or data, and/or otherwise interacting with the virtual meeting platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the virtual meeting platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some implementations, any element, such as server 130, and/or data store 106 may include a corresponding API endpoint for communicating with APIs.

In some implementations, virtual meeting platform 120 and/or server 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a virtual meeting. Virtual meeting platform 120 can also include a website (e.g., a webpage) or application back-end software that may be used to enable a user to connect with other users via virtual meeting 121.

The system can include a AI model 160. In some implementations, the AI model 160 is an artificial intelligence (AI) model (e.g., also referred to as an “machine learning (ML) model” herein). An AI model can include a discriminative machine learning model (also referred to as “discriminative AI model” herein), a generative machine learning model (also referred to as “generative AI model”herein), and/or other AI model(s).

In some implementations, a discriminative AI model can model a conditional probability of an output for given input(s). A discriminative AI model can learn the boundaries between different classes of data to make predictions on new data. In some implementations, a discriminative AI model can include a classification model that is designed for classification tasks, such as learning decision boundaries between different classes of data and classifying input data into a particular classification. Examples of discriminative AI models include, but are not limited to, support vector machines (SVM) and neural networks.

In some implementations, a generative AI model learns how the input training data is generated and can generate new data (e.g., original data). A generative AI model can model the probability distribution (e.g., joint probability distribution) of a dataset and generate new samples that often resemble the training data. Generative AI models can be used for tasks involving image generation, text generation and/or data syn-thesis. Generative AI models include, but are not limited to, gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and so forth.

Server 130 includes a training set generator 131 that is capable of generating training data (e.g., a set of training inputs and a set of target outputs) to train the AI model 160 (e.g., a generative machine learning model). In some implementations, training set generator 131 can generate the training data based on various data (e.g., stored at data store 106 or another data store connected to system 100 via the network 108). The data store 106 can store metadata associated with the training data.

Server 140 includes a training engine 141 that is capable of training a AI model 160 using the training data from training set generator 131. The AI model 160 (also referred to “machine learning model” or “artificial intelligence (AI) model” herein) may refer to the model artifact that is created by the training engine 141 using the training data that includes training inputs (e.g., features) and corresponding target outputs (correct answers for respective training inputs) (e.g., labels). The training engine 141 may find patterns in the training data that map the training input to the target output (the answer to be predicted) and provide the AI model 160 that captures these patterns. The AI model 160 may be composed of, e.g., a single level of linear or non-linear operations (e.g., a support vector machine (SVM), or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. AI model 160 can use one or more of a support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. For convenience rather than limitation, the remainder of this disclosure describing a discriminative machine learning model will refer to the implementation as a neural network, even though some implementations might employ other types of learning machine instead of, or in addition to, a neural network.

In some implementations, such as with a supervised machine learning model, the one or more training inputs of the set of the training inputs are paired with respective one or more training outputs of the set of training outputs. The training input-output pair(s) can be used as input to the machine learning model to help train the machine learning model to determine, for example, patterns in the data.

In some implementations, the AI model 160 can be a generative AI model. A generative AI model is an AI model which can generate new, original data. A AI model 160 can include a generative adversarial network (GAN) and/or a variational autoencoder (VAE). In some instances, a GAN, a VAE, and/or other types of generative AI models can employ different approaches to training and/or learning the underlying probability distributions of training data, compared to some AI models.

For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In some implementations, the AI model 160 can be a generative large language model (LLM). In some implementations, the AI model 160 can be a large language model that has been pre-trained on a large corpus of data so as to process, analyze, and generate human-like text based on given input.

In some implementations, the AI model 160 may have any architecture for LLMs, including one or more architectures as seen in Generative Pre-trained Transformer (GPT) series (Chat GPT series LLMs), Google's Gemini®, or LaMDA, or leverage a combination of transformer architecture with pre-trained data to create coherent and contextually relevant text.

In some implementations, a AI model 160, such as an LLM, can use an encoder-decoder architecture including one or more self-attention mechanisms, and one or more feed-forward mechanisms. In some implementations, the AI model 160 can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A AI model 160 can also utilize the previously discussed deep learning techniques, including recurrent neural networks (RNNs), convolutional neural networks (CNNs), or transformer networks.

In some implementations, the AI model 160 can be a multi-modal generative AI model, such as a Visual-Language Model (VLM). In some implementations, the AI model 160 can be a VLM that has been pre-trained on a large corpus of data (e.g., textual data and image data) so as to process, analyze, and generate human-like text and/or image data based on given input (e.g., image data and/or natural language text).

In some implementations, training a generative AI model can include providing training input to a AI model 160, and the AI model 160 can produce one or more training outputs. The one or more training inputs can be compared to one or more evaluation metrics. An evaluation metric can refer to a measure used to assess the output (e.g., training output(s)) of a AI model, such as a AI model 160. In some implementations, the evaluation metric can be specific to the task and/or goals of the AI model. Based on the comparison, one or more parameters and/or weights of the AI model 160 can be adjusted (e.g., backpropagation based on computed loss). In some implementations, and for example, the one or more training outputs can be compared to an evaluation metric such as a ground truth (e.g., target output, such as a correct or better answer). In some implementations and for example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In some implementations, a validation engine (not shown) may be capable of validating a AI model 160 using a corresponding set of features of a validation set from the training set generator. In some implementations, the validation engine may determine an accuracy of each of the trained generative models, such as AI model 160 (e.g., accuracy of the training output) based on the corresponding sets of features of the validation set. The validation engine may discard a trained AI model 160 that has an accuracy that does not meet a threshold accuracy. In some implementations, a selection engine not shown) may be capable of selecting a AI model 160 that has an accuracy that meets a threshold accuracy. In some implementations, the selection engine may be capable of selecting the trained AI model 160 that has the highest accuracy of the trained generative models (e.g., AI model 160).

A testing engine (not shown) may be capable of testing a trained AI model 160 using a corresponding set of features of a testing set from the training engine 141. For example, a first trained AI model 160 that was trained using a first set of features of the training set may be tested using the first set of features of the testing set. The testing engine may determine a trained AI model 160 that has the highest accuracy of all of the trained AI models based on the testing sets.

In some implementations, a AI model 160 can be trained on a corpus of data, such textual data and/or image data. In some implementations, the AI model 160 can be a model that is first pre-trained on a corpus of text to create a foundational model (e.g., also referred to as “pre-trained model” herein), and afterwards adapted (e.g., fine-tuned or transfer learning) on more data pertaining to a particular set of tasks to create a more task-specific or targeted generative AI model (e.g., also referred as an “adapted model” herein.) The foundational model can first be pre-trained using a corpus of data (e.g., text and/or images) that can include text and/or image content in the public domain, licensed content, and/or proprietary content (e.g., proprietary organizational data). The AI model 160 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that the AI model 160 is to be adapted. In some implementations, AI model 160 may include one or more pre-trained models or adapted models.

In some implementations, training data, such as training input and/or training output, and/or input data to a trained machine learning model (collectively referred to as “machine learning model data” herein) can be preprocessed before providing the aforementioned data to the (trained or untrained) machine learning model (e.g., discriminative machine learning model and/or generative machine learning model) for execution. Preprocessing as applied to machine learning models (e.g., discriminative machine learning model and/or generative machine learning model) can refer to the preparation and/or transformation of machine learning model data.

In some implementations, preprocessing can include data scaling. Data scaling can include a process of transforming numerical features in raw machine learning model data such that the preprocessed machine learning model data has a similar scale or range. For example, Min-Max scaling (Normalization) and/or Z-score normalization (Standardization) can be used to scale the raw machine learning model. For instance, if the raw machine learning model data includes a feature representing temperatures in Fahrenheit, the raw machine learning model data can be scaled to a range of [0, 1] using Min-Max scaling.

In some implementations, preprocessing can include data encoding. Encoding data can include a process of converting categorical or text data into a numerical format on which a machine learning model can efficiently execute. Categorical data (e.g., qualitative data) can refer to a type of data that represents categories and can be used to group items or observations into distinct, non-numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, “small,” “medium,” and “large” can be considered categorical data (ordinal categorical data with an inherent ranking or order). An example of encoding can include encoding a size feature with categories [“small,” “medium,” “large”] by assigning 0 to “small,” 1 to “medium,” and 2 to “large. ”

In some implementations, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by machine learning models. In some implementations embedding data can represent original data (e.g., word, phrase, document, or entity) as a vector in vector space, such as continuous vector space. Each element (e.g., dimension) of the vector can correspond to a feature or property of the original data (e.g., object). In some implementations, the size of the embedding vector (e.g., embedding dimension) can be adjusted during model training. In some implementations, the embedding dimension can be fixed to help facilitate analysis and processing of data by machine learning models.

In some implementations, the training set is obtained from server 130. Server 150 includes a private audio module 151 that provides current data (e.g., log information, etc.) as input to the trained machine learning model (e.g., AI model 160) and runs the trained machine learning model (e.g., AI model 160) on the input to obtain one or more outputs.

In some implementations, confidence data can include or indicate a level of confidence of that a particular output (e.g., output(s)) corresponds to one or more inputs of the machine learning model (e.g., trained machine learning model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some implementations, confidence data can be associated with inference using a machine learning model.

In some implementations, a machine learning model, such as AI model 160, may be (or may correspond to) one or more computer programs executed by processor(s) of server 140 and/or server 150. In other implementations, a machine learning model may be (or may correspond to) one or more computer programs executed across a number or combination of servers. For example, in some implementations, machine learning models may be hosted on the cloud, while in other implementations, these machine learning models may be hosted and perform operations using the hardware of a client devices 102A-102N. In some implementations, the machine learning models may be a self-hosted machine learning model, while in other implementations, machine learning models may be external machine learning models accessed by an API.

It is appreciated that in some other implementations, the functions of server 130 or virtual meeting platform 120 can be provided by a fewer number of machines. For example, in some implementations, server 130 can be integrated into a single machine, while in other implementations, server 130 can be integrated into multiple machines. In addition, in some implementations, server 130 can be integrated into virtual meeting platform 120.

In general, functions described in implementations as being performed by virtual meeting platform 120 or server 130 can also be performed by the client devices 102A-102N and/or client device(s) 104 in other implementations, if appropriate. In addition, the functionality attributed to a particular component can be performed by different or multiple components operating together. Virtual meeting platform 120 and/or server 130 may also be accessed as a service provided to other systems or devices through appropriate application programming interfaces, and thus is not limited to use in websites.

Although implementations of the disclosure are discussed in terms of virtual meeting platform 120 and users of virtual meeting platform 120 participating in a virtual meeting, implementations can also be generally applied to any type of telephone call or conference call between users. Implementations of the disclosure are not limited to virtual meeting platforms that provide virtual meeting tools to users.

In implementations of the disclosure, a “user” or “participant” can be represented as a single individual. However, other implementations of the disclosure encompass a “user” or “participant” being an entity controlled by a set of users and/or an automated source. For example, a set of individual users federated as a community in a social network may be considered a “user” or “participant. ” In another example, an automated consumer can be an automated ingestion pipeline, such as a topic channel, of the virtual meeting platform 120.

In situations in which the systems discussed here collect personal information about users, or may make use of personal information, the users can be provided with an opportunity to control whether virtual meeting platform 120 collects user information (e.g., information about a user's social network, social actions or activities, profession, a user's preferences, or a user's current location), or to control whether and/or how to receive content from the server 130 that can be more relevant to the user. In addition, certain data can be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the virtual meeting platform 120 and/or server 130.

FIG. 2 is an example block diagram 200 for using a private audio module 251 to generate outputs 202 based on inputs 201, according to some aspects of the disclosure. In some implementations, the private audio module 251 is the same as or similar to the private audio module 151 described in FIG. 1. In some implementations, the private audio module 251 can include or use one or more AI models (e.g., AI model 160 as described in FIG. 1) to generate the outputs 202 based on the inputs 201.

Inputs 201 includes distorted audio data 252. Distorted audio data 252 includes distorted participant voice data 254 reflecting a distorted tone of voice 253 (illustrated in dashed lines). Distorted audio data 252 can be the same as or similar to distorted audio data 152 as described with reference to FIG. 1. A distorted tone of voice 253 can be the same as or similar to distorted tone of voice 153 as described with reference to FIG. 1.

The distorted audio data can include distorted participant voice data 254, non-participant voice data 255, and non-voice data 256. The non-participant voice data 255 can refer to voice data of non-participants (e.g., human voice data). For example, a participant may be speaking in a virtual meeting, and another person in the background (e.g., a non-participant) may also be speaking. The non-voice data 256 can refer to background audio, or ambient noise. Examples of non-voice data 256 can include a low-battery smoke detector beep, traffic sounds, siren sounds, barking dogs, or the like. In some implementations, non-voice data 256 can include music, instrumental sounds, or the like.

The distorted audio data 252 can be received as input to the private audio module 251. In some implementations, the private audio module 251 can prompt the participant to provide the distorted audio data 252. In some implementations, the private audio module 251 can include one or more trained AI models (e.g., AI model 160 as described with reference to FIG. 1) that can generate outputs 202 from inputs 201 (e.g., the distorted audio data 252). In some implementations, the private audio module 251 can separate the elements of the distorted audio data 252 from the distorted audio data 252. For example, and in some implementations, the private audio module can remove the non-participant voice data 255 and the non-voice data 256 from the distorted audio data 252, leaving the participant voice data associated with the distorted tone of voice 253.

In some implementations, different AI models or algorithms can be used to process elements of the distorted audio data 252. For example, a noise isolation model (e.g., the isolation model 160C of FIG. 1) can remove the non-voice data 256 from the distorted audio data 252. A voice isolation model (e.g., the isolation model 160C)can remove non-participant voice data 255 from the distorted audio data 252. A voice characteristic extraction model (e.g., the modification model 160B)can determine the characteristics of the distorted tone of voice 253. A voice modification model (e.g., modification model 160B) can perform one or more modifications to the distorted tone of voice 253 to generate a modified tone of voice 273 for modified participant voice data 274. An audio generation model (e.g., modification model 160B) can generate the modified audio data 272 from the modified participant voice data 274 reflecting the modified tone of voice 273.implementations

The modified audio data 272 can be used by a virtual meeting platform (e.g., virtual meeting platform 120 as described with reference to FIG. 1) in a virtual meeting (e.g., virtual meeting 121 of FIG. 1) to represent speech of the participant. In some implementations, the restored participant voice data 274 of the modified audio data 272 can reflect a modification of the distorted audio data 252. Modifications of the distorted audio data 252 reflected in the modified audio data 272 can include one or more of a speech volume modification, a speech intonation modification, a speech articulation modification, a speech speed modification, or a speech pronunciation modification.

In some implementations, the restored participant voice data 274 can reflect voice data of the participant speaking in a regular voice (as opposed to voice data of the participant speaking in a distorted tone of voice 253). In some implementations, the private audio module 251 can generate a level of confidence that the sound of the restored participant voice data 274 reflects a regular voice of the participant.

FIG. 3 is a block diagram 300 that illustrates the inputs 301 and outputs 303 for AI models of a private audio module 351 of the virtual meeting platform, according to some aspects of the disclosure. In some implementations, the private audio module 351 can be the same as or similar to the private audio module 151 described with reference to FIG. 1.

The virtual meeting platform (e.g., virtual meeting platform 120) can provide inputs 301 to a private audio module 351 to produce the outputs 303. The private audio module 351 can use one or more AI models, here illustrated as transformation model 360A, modification model 360B, and isolation model 360C to produce the outputs 303.

The transformation model 360A receives participant voice data 362 as input and generates transformation data 361 as output. The participant voice data 362 can include participant distorted voice data 363 and participant regular voice data 364. The participant can provide the participant distorted voice data 363 and the participant regular voice data 364 to a model or algorithm that generates the transformation data 361. In some implementations, the transformation data 361 can be generated asynchronously from the remaining operations performed by the private audio module 351. For example, and in some implementations, the transformation data 361 can be generated prior to receiving the inputs 301 at the private audio module 351. A client device (e.g., client devices 102A-102N) can capture audio data of a participant prior to a virtual meeting (e.g., virtual meeting 121). The captured audio data including the participant voice data 362 can be provided by the private audio module 351 to the transformation model 360A as an input. The transformation model can generate transformation data 361 as an output, based on the participant voice data 362. The transformation data 361 is used to set model parameters 369 of the modification model 360B, as described with reference to FIG. 1. In some implementations, the transformation data 361 can include information indicating one or more modifications to be performed to voice data received as input to the modification model 360B to generate the desired outputs (e.g., modified audio data 372). In alternative implementations, the transformation data 361 can include information indicating one or more modifications to characteristics associated with a tone of voice (e.g., a distorted tone of voice 353) of the voice data provided to the modification model 360B for the modification model 360B to generate the modified tone of voice 373 reflected by the modified participant voice data 374.

During a virtual meeting, the inputs 301 can be provided as input to the isolation model 360C by the private audio module 351. That is, the private audio module 351 can receive the inputs 301 from a client device, and produce the outputs 303 to be used in the virtual meeting in real-time. The inputs 301 include distorted audio data 352. Distorted audio data 352 includes distorted participant voice data 354 reflecting the distorted tone of voice 353, non-participant voice data 355, and non-voice data 356. The isolation model 360C removes the non-participant voice data 355 and the non-voice data 356 to generate distorted participant voice data 354 reflecting the distorted tone of voice 353. In some implementations, the isolation model 360C isolates the distorted participant voice data 354 from the distorted audio data 352 with two operations. Each operation can be performed by a separate isolation model 360C, or a first portion and second portion of the isolation model 360C, respectively. During the first operation, the non-voice data 356 is removed from the distorted audio data 352 by the isolation model 360C. During the second operation, the non-participant voice data 355 is removed from the distorted audio data 352. In alternative implementations, the isolation model 360C can extract the distorted participant voiced data 354 reflecting the distorted tone of voice 353 from the distorted audio data 352. In some implementations, the participant voice data 362 collected for the transformation model 360A can be used to improve the ability of the isolation model 360C to separate the distorted participant voice data 354 from the distorted audio data 352.

The distorted participant voice data 354 reflecting the distorted done of voice 353 (e.g., the output produced by the isolation model 360C) can be provided as input to the modification model 360B by the private audio module 351. The modification model 360B generates the outputs 303 of the modified audio data 372 based on an input of the distorted participant voice data 354. As illustrated, the modified audio data 372 can include modified participant voice data 374 which reflects the modified tone of voice 373. In some implementations, the modified audio data 372 can include representations of the non-participant voice data 355 and non-voice data 356. For example, the modified audio data 372 can include modified non-participant voice data and modified non-voice data 356. In some implementations, the private audio module 351 can perform additional operations on the modified audio data 372 before causing the modified audio data 372 to be used in place of the distorted participant voice data 354 in the virtual meeting.

FIG. 4 is an example block diagram 400 of using a training engine 441 to generate outputs 403 based on inputs 401, according to some aspects of the disclosure. In some implementations, the training engine 441 is the same as or similar to the training engine 141 described in FIG. 1. In some implementations, the training engine 441 is used to train a supervised AI model. In some implementations, the training engine 441 is used to train an unsupervised AI model. In some implementations, the training engine 441 is used to train a discriminative AI model. In some implementations, the training engine 441 is used to train a generative AI model.

The inputs 401 include a first training audio data 410A through Mth first training audio data 410M and participant first training audio data 410N, and a second training audio data 420A through Mth second training audio data 420M and participant second training audio data 420N. The first training audio data 410A associated with the suppressed tone of voice 411A can correspond to the second training audio data 420A associated with the dynamic tone of voice 421A. The Mth first training audio data 410M can similarly correspond to the Mth second training audio data 420M. The participant first training audio data 410N associated with the suppressed tone of voice 411N can correspond to the participant second training audio data 420N associated with the dynamic tone of voice 421N. In some implementations, each of the training audio data (e.g., first training audio data 410A through Mth first training audio data 410M) can be associated with a different data set obtained from a respective person. That is, first training audio data 410A and second training audio data 420A can be associated with (and obtained from) a first person, Mth first training audio data 410M and Mth second training audio data 420M can be associated with (and obtained from) an Mth person, participant first training audio data 410N and participant second training audio data 420N can be associated with (and obtained from) a respective participant (e.g., the participant using the trained model).

The training engine 441 can train a model to receive first training audio data and second training audio data as input and generate modified audio data 430 as an output. In some implementations, the training engine 441 can train the model using first training audio data 410A through Mth first training audio data 410M and corresponding participant second training audio data 420A through Mth second training audio data 420M. The resulting trained model (also referred to herein as a “base model”) can be trained to generate modified audio data 430 based on an input audio data.

In some implementations, the training engine 441 can further train a base model (e.g., a pretrained model) using participant first training audio data 410N and corresponding participant second training audio data 420N. The further training of the base model can enable the retrained model to more accurately generate modified audio data 430 for a particular participant (e.g., the participant that provided the participant first training audio data 410N and corresponding participant second training audio data 420N).

In some implementations, the training engine 441 can train the model to determine a relationship between the suppressed tone of voice 411A of the first training audio data 410A and the dynamic tone of voice 421A of the second training audio data 420A, and so on for each of the Mth first training audio data 410M and participant first training audio data 410N. The resulting trained model can receive audio data associated with a suppressed tone of voice as an input 401 and generate a modified audio data 430 associated with a target tone of voice 431 as an output. It can be appreciated that while the descriptions for this figure refer to a suppressed tone of voice and dynamic tone of voice, that a model can be trained to identify and generate other types of voice tones. For example, the training engine 441 can similarly train an AI model to receive as input, an anxious tone of voice and generate a calm tone of voice. In another example, the training engine 441 can similarly train an AI model to receive as input, a male-sounding tone of voice and generate a female-sounding tone of voice. In another example, the training engine 441 can similarly train an AI model to receive as input, a tone of voice lacking certain auditory characteristics and generate a modified tone of voice that includes desired auditory characteristics.

The target tone of voice 431 of the modified audio data 430 can reflect a dynamic tone of voice of the participant. In some implementations, the modified audio data 430 includes voice data similar to voice data of a participant's regular voice (e.g., speaking with a dynamic tone of voice).

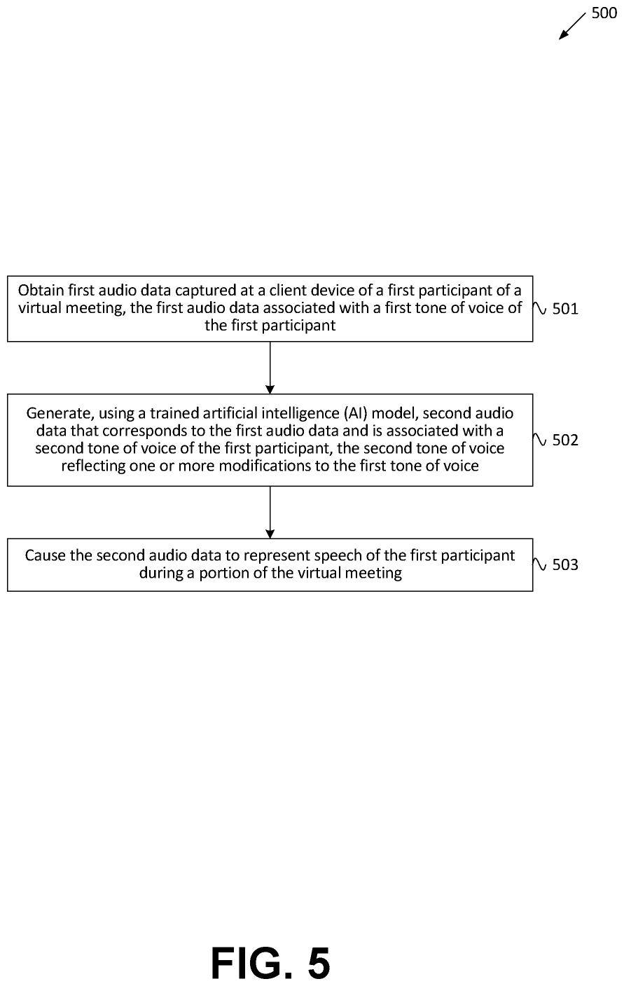

FIG. 5 is a flow diagram of an example method 500 for private audio transmission in virtual meetings using artificial intelligence (AI), according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 501, the processing logic performing the method 500 obtains distorted audio data (e.g., first audio data) captured at a client device of a particular participant of a virtual meeting. In some implementations, the distorted audio data is associated with a distorted tone of voice of the particular participant.

The distorted audio data can include distorted voice data of the first participant. The distorted voice data can be associated with the distorted tone of voice. In some implementations, the processing logic can use a trained AI model (e.g., an isolation model) to remove non-voice data and non-participant voice data from the distorted audio data. In some implementations, the isolation model is trained on training voice data of the first participant to extract the distorted voice data of the particular participant from the distorted audio data. That is, the isolation model can be trained to recognize the distorted voice data or distorted tone of voice reflected by the distorted voice data of the particular participant. The isolation model can receive the distorted audio data as an input, and generate an output of the distorted voice data. In some implementations, the isolation model can generate an output of auditory characteristics corresponding to a distorted tone of voice reflected by the distorted voice data.

At operation 502, the processing logic generates, using a trained AI model (e.g.,. a modification model), modified audio data that corresponds to the distorted audio data. The modification model can receive distorted audio data as an input and generate modified audio data as an output. In some implementations, the modification model can receive distorted voice data as an input and generate modified voice data as an output. The parameters of the modification model can be based on participant voice data provided prior to a virtual meeting (e.g., during a voice training session). In some implementations, another trained AI model (e.g., a transformation model) can be used to determine one or more modifications to be performed to a distorted voice to produce a modified voice, as described above. In some implementations, the modified audio data reflects a modified tone of voice of the first participant. In some implementations, the modified tone of voice represents one or more modifications to the distorted tone of voice of the first participant. In some implementations, the modified tone of voice can be generated by the modification model based on modifications to one or more auditory characteristics associated with the distorted tone of voice, as determined by the transformation model. Auditory characteristics can include, for example, a volume characteristic, an intonation characteristic, an articulation characteristic, a speed characteristic, or a pronunciation characteristic.

In some implementations, audio data that was removed from the distorted audio data by the isolation model before the distorted audio data was processed by the modification model can be re-added to the modified audio data. For example, non-voice data and non-participant voice data can be removed from the distorted audio data before it is processed by the modification model. The removed non-voice data and non-participant voice data can be re-added to the modified audio data. In some implementations, the modification model can re-add the removed audio data. In some implementations representations of the non-voice data and non-participant voice data can be re-added to the modified audio data (e.g., modified non-voice data and modified non-participant voice data).

In some implementations, the processing logic can determine a level of confidence that the modified tone of voice reflected by the modified voice data matches a regular tone of voice of the first participant. In some implementations, the level of confidence is determined using the modification model. A confidence indicator based on the determined level of confidence can be displayed (or cause to be displayed) to the first participant via a graphical user interface (GUI). In some implementations, the confidence indicator (e.g., indicating a level of confidence that the modified tone of voice matches a regular tone of voice of the participant) can be displayed to other participants of the virtual meeting. In some implementations, an indicator that the modified audio data (including the modified tone of voice) has been modified or generated by AI can be displayed to participants of the virtual meeting via respective GUIs of each participant.

At operation 503, the processing logic causes the modified audio data to be used in place of distorted participant audio data captured by a client device, during a portion of the virtual meeting. In some implementations, the processing logic can receive, through a GUI of the first participant, a user input to request that the distorted audio data be used to represent speech of the first participant during a second portion of the virtual meeting. That is, the virtual meeting platform can determine to generate modified audio data for a portion of the virtual meeting, and subsequently determine not to generate modified audio data for another portion of the virtual meeting, and vice versa. In some implementations, the virtual meeting platform can implement GUI controls for configuring settings of the virtual meeting (e.g., virtual meeting 121 of FIG. 1). In some implementations, the determination to generate modified audio data for the portion of the meeting can be based on a user input received via the GUI controls for the virtual meeting. In some implementations, the user input is received from the participant. In some implementations, the user input is received from a host of the virtual meeting (who is not the first participant). In response to determining to not generate modified audio data, the processing logic can cause the distorted audio data (e.g., the original audio data captured by the client device of the first participant) to represent the speech of the first participant during the second portion of the virtual meeting. That is, the distorted audio data is transmitted to client devices of the virtual meeting.

In some implementations, the processing logic can generate a first text transcript for the distorted audio data and/or a second text transcript for the modified audio data. The processing logic can generate, based on the first text transcript and the second text transcript, a first participant text transcript for speech spoken by the first participant during the virtual meeting. In some implementations, the processing logic can use the first text transcript and the second text transcript to determine whether the modified audio data accurately represents the distorted audio data. In some implementations, the processing logic can use the first text transcript and the second text transcript to determine a level of confidence that second voice data (e.g., restored voice data) of the modified audio data corresponds to first voice data (e.g., participant voice data) of the distorted audio data.

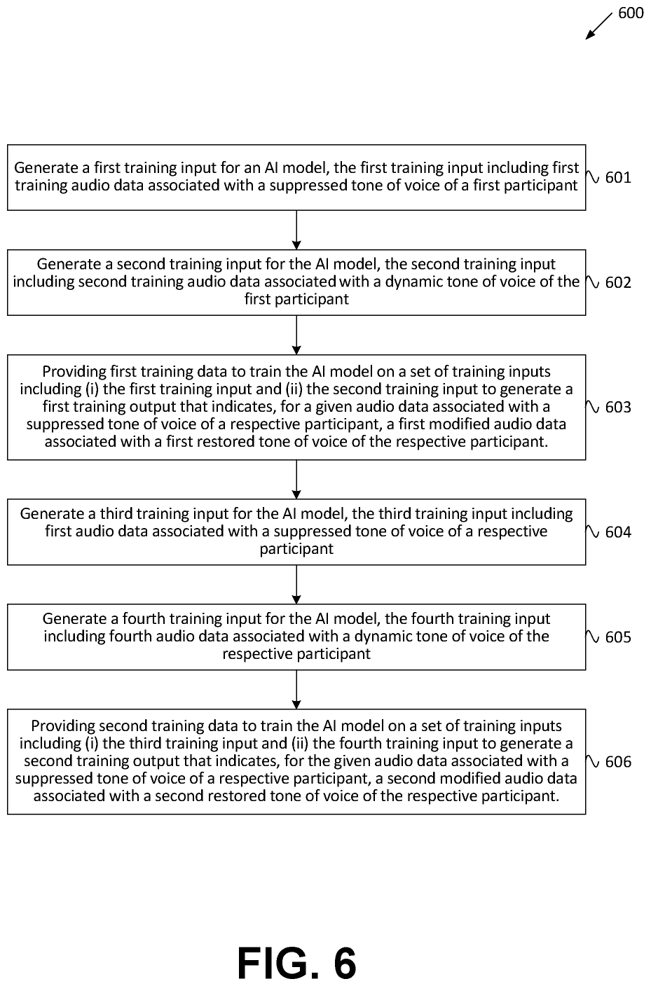

FIG. 6 is a flow diagram of an example method 600 for private audio transmission in virtual meetings using artificial intelligence (AI), according to some aspects of the disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 601, the processing logic performing the method 600 generates a suppressed voice training input for an AI model. The suppressed voice training input can include training audio data reflecting a suppressed tone of voice of a participant. In some implementations, the processing logic removes non-voice data from the suppressed voice training audio data. In some implementations, the processing logic removes non-participant voice data from the suppressed voice training audio data.

At operation 602, the processing logic generates a dynamic voice training input for the AI model. The dynamic voice training input can include training audio data reflecting a dynamic tone of voice of the participant. In some implementations, the processing logic removes non-voice data from the training audio data. In some implementations, the processing logic removes non-participant voice data from the training audio data.

At operation 603, the processing logic provides training data to train the AI model on a set of training inputs including (i) the suppressed voice training input and (ii) the dynamic voice training input to generate a training output. The training output can indicate, for a given audio data reflecting a suppressed tone of voice of a respective participant, a modified audio data reflecting a modified tone of voice of the respective participant. In some implementations, the modified audio data reflects a transformation of one or more characteristics of the suppressed tone of voice of the respective participant. The one or more characteristics can include at least one of a volume characteristic, an intonation characteristic, an articulation characteristic, a speed characteristic, or a pronunciation characteristic.

At operation 604, the processing logic generates a suppressed participant voice training input for the AI model. The suppressed participant voice training input can include audio data reflecting a suppressed tone of voice of a respective participant.

At operation 605, the processing logic generates a dynamic participant voice training input for the AI model. The dynamic participant voice training input can include audio data reflecting a dynamic tone of voice of the respective participant.

At operation 606, the processing logic provides training data to further train the AI model on a set of training inputs including (i) the suppressed participant voice training input and (ii) the dynamic participant voice training input to generate another training output. The training output can indicate, for a received audio data associated with a suppressed tone of voice of a respective participant, a modified audio data reflecting a modified tone of voice of the respective participant. In some implementations, the processing logic can generate a level of confidence that the modified tone of voice matches a regular tone of voice of the respective participant. In some implementations, the level of confidence can be generated by the AI model.

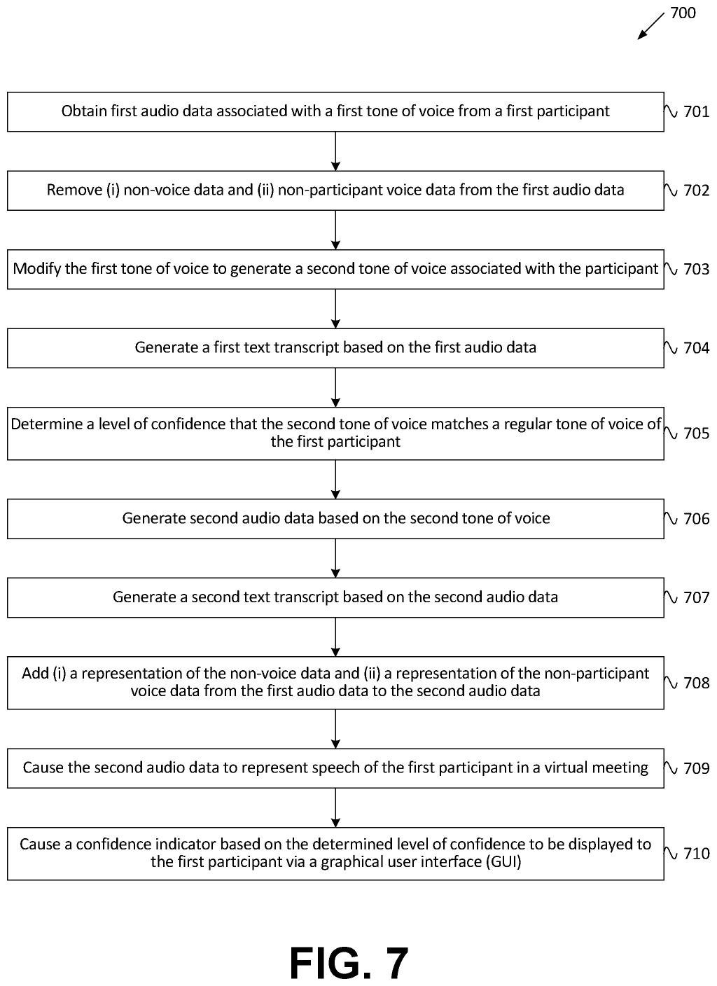

FIG. 7 is a flow diagram of an example method 700 for private audio transmission in virtual meetings using artificial intelligence (AI), according to some aspects of the disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 701, the processing logic performing the method 700 obtains distorted audio data associated with a distorted tone of voice from a first participant. In some implementations, the processing logic can cause a GUI of a client device associated with the first participant to display a prompt to the first participant. The prompt can request that the first participant provide distorted audio data via a respective client device. In some implementations, the distorted audio data is captured in the normal course of operating a virtual meeting. That is, when the microphone of the client device is activated for the first participant to use in the virtual meeting, the distorted audio data is captured via the microphone of the client device.

At operation 702, the processing logic removes (i) non-voice data and (ii) non-participant voice data from the distorted audio data. In some implementations, the non-voice data can include ambient noise, or background audio data. In some implementations, the non-participant voice data can include human voices from non-participants that may be captured by a microphone or audio capture device used by the first participant for the virtual meeting. In some implementations, the non-voice data and/or the non-participant voice data can be saved for additional processing.

At operation 703, the processing logic modifies the distorted tone of voice to generate a modified tone of voice associated with the participant. In some implementations, the processing logic uses an AI model that is trained to generate a modified tone of voice based on an input tone of voice. The distorted tone of voice can be provided as input to the trained AI model (e.g., a modification model), and the trained AI model can generate an output of the modified tone of voice. In some implementations, the modified tone of voice is based on a regular voice of the first participant. In some implementations, the modified tone of voice is based on target characteristics of a tone of voice. For example, desired characteristics can be based on a speech volume, speech intonation, speech articulation, speech speed, speech pronunciation, or the like. In some implementations, the parameters of the trained AI model are determined prior to use of the AI model. The processing logic can capture audio data of the first participant in a controlled environment and use the captured audio data to determine parameters of the trained AI model.

At operation 704, the processing logic generates a first text transcript based on the distorted audio data.

At operation 705, the processing logic determines a level of confidence that the modified tone of voice matches a regular tone of voice of the first participant. In some implementations, if the level of confidence does not satisfy a threshold level of confidence, the processing logic can halt the method 700. In some implementations, if the level of confidence does not satisfy a threshold level of confidence, the processing logic can cause an indication reflecting the failure to satisfy the threshold level of confidence to be displayed via a GUI of the first participant. In some implementations, if the level of confidence does not satisfy the threshold level of confidence, the processing logic can cause a request to be displayed to the participant. The request can indicate that the participant should provide additional training data to be used to improve the ability of the AI model to generate the modified tone of voice from the distorted tone of voice.

At operation 706, the processing logic generates modified audio data based on the modified tone of voice. In some implementations, the processing logic can determine a level of confidence that the modified audio data corresponds to the distorted audio data. In some implementations, the modified audio data can be generated by the trained AI model (e.g., the modification model) when the modification model generates the modified tone of voice (not illustrated).

At operation 707, the processing logic generates a second text transcript based on the modified audio data.

At operation 708, the processing logic adds (i) a representation of the non-voice data, and (ii) a representation of the non-participant voice data from the distorted audio data to the modified audio data. In some implementations, one or more of the non-voice data of the distorted audio data or the non-participant voice data of the distorted audio data can be added to the modified audio data. In some implementations, one or more of the non-voice data or the non-participant voice data can be modified before being added to the modified audio data.

At operation 709, the processing logic causes the modified audio data to represent speech of the first participant in a virtual meeting. That is, the processing logic causes the modified audio data to be used in place of the distorted audio data that was captured by the client device used by the participant to join the virtual meeting. In some implementations, the processing logic determines whether the modified audio data should not be used in place of the distorted audio data. That is, the processing logic can determine during the virtual meeting to use either the distorted audio data or the modified audio data to represent speech of the participant. In some implementations, the determination is based on a user input received via a GUI of a client device associated with the participant.

At operation 710, the processing logic causes a confidence indicator based on the determined level of confidence (that the modified tone of voice matches the regular tone of voice) to be displayed to the first participant via a GUI. In some implementations the confidence indicator can be displayed to other participants of the virtual meeting. In some implementations, the processing logic causes a visual element indicating that the modified audio data has been generated using generative AI to be displayed to participants of the virtual meeting.

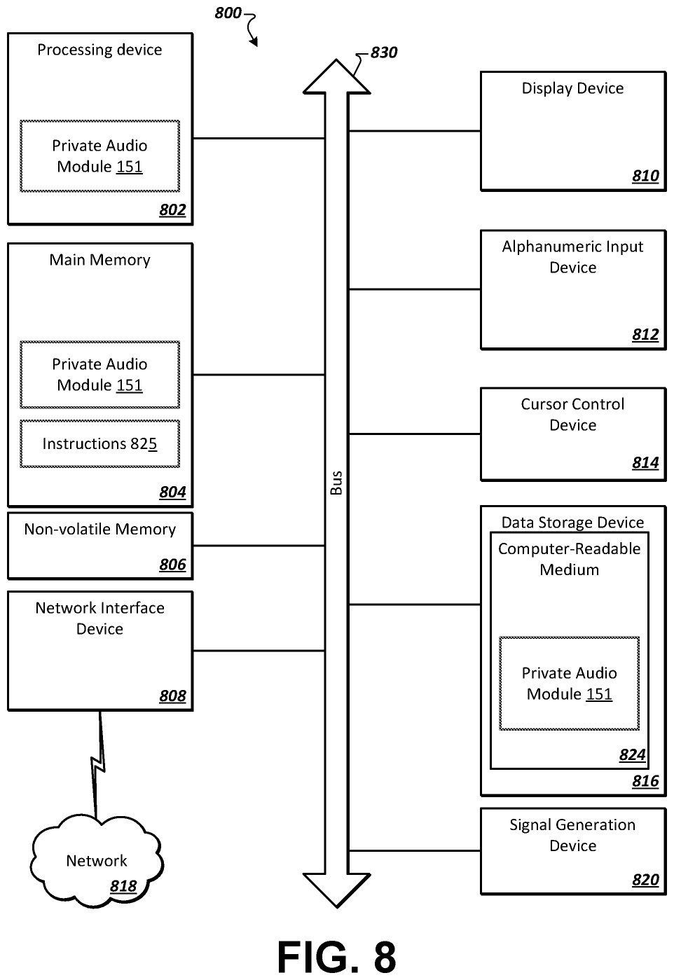

FIG. 8 is a block diagram illustrating an example of a computer system 800, according to aspects of the disclosure. The computer system 800 can correspond to virtual meeting platform 120 and/or client devices 102A-102N, described in FIG. 1. Computer system 800 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 800 includes a processing device 802 (e.g., a processor), a main memory 804 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 806 (e.g., flash memory, static random access memory (SRAM), etc.), and a data storage device 816, which communicate with each other via a bus 830. In some implementations, the main memory 804 can be a non-transitory computer readable storage medium.

Processing device 802 represents one or more general-purpose processing devices such as a microprocessor, central processing unit, or the like. More specifically, processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute network interface device 808 (e.g., for synchronizing data between platforms) for performing the operations discussed herein. The processing device 802 can be configured to execute instructions 825 stored in main memory 804. Non-volatile memory 806 can store the instructions 825 when they are not being executed, and can store additional system data that can be accessed by processing device 802.

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a computer-readable storage medium 824 (e.g., a non-transitory machine-readable storage medium) on which is stored one or more sets of instructions 825 (e.g., for generating variations of a translated audio portion) embodying any one or more of the methodologies or functions described herein. The instructions can also reside, completely or at least partially, within the main memory 804 and/or within the one or more processing devices (e.g., the processing device 802) during execution thereof by the computer system 800, the main memory 804 and the processing device 802 also constituting machine-readable storage media. The instructions can further be transmitted or received over a network 820 via the network interface device 808. In some implementations, one or more processing devices can be operatively coupled to the main memory 804 to perform various operations.

While the computer-readable storage medium 824 (non-transitory computer-readable storage medium) is illustrated in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding, or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a specific feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the specific features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, modules, and so on have been described with respect to interactions between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
obtaining distorted audio data captured at a client device of a first participant of a plurality of participants of a virtual meeting, wherein the distorted audio data is associated with a distorted tone of voice of the first participant;
generating, using a first trained artificial intelligence (AI) model, modified audio data that corresponds to the distorted audio data and is associated with a modified tone of voice of the first participant, the modified tone of voice reflecting one or more modifications to the distorted tone of voice; and
causing the modified audio data to represent speech of the first participant during a first portion of the virtual meeting between the plurality of participants.

2. The method of claim 1, wherein the distorted tone of voice is associated with first voice data of the first participant, the method further comprising:
removing, using a second trained AI model, (i) non-voice data and (ii) non-participant voice data from the distorted audio data, wherein the second trained AI model is trained on training voice data of the first participant to extract the first voice data of the first participant from the distorted audio data.

3. The method of claim 2, further comprising:
adding, to the modified audio data generated by the first AI model, (i) the non-voice data of the distorted audio data and (ii) the non-participant voice data of the distorted audio data.

4. The method of claim 1, wherein the distorted tone of voice comprises one or more of a volume characteristic, an intonation characteristic, an articulation characteristic, a speed characteristic, or a pronunciation characteristic.

5. The method of claim 1, further comprising:
determining, using the first trained AI model, a level of confidence that the modified tone of voice matches a regular tone of voice of the first participant; and
causing a confidence indicator to be displayed to the first participant via a graphical user interface (GUI) of the client device, the confidence indicator being based on the determined level of confidence.

6. The method of claim 1, further comprising:
receiving, through a graphical user interface (GUI) of the client device, user input to request that the distorted audio data represent speech of the first participant during a second portion of the virtual meeting; and
responsive to receiving the user input, causing the distorted audio data to represent the speech of the first participant during the second portion of the virtual meeting.

7. The method of claim 1, further comprising:
generating a first text transcript of the distorted audio data;
generating a second text transcript of the modified audio data; and
generating, based on the first text transcript and the second text transcript, a first participant text transcript for the first participant.

8. The method of claim 1, further comprising:
causing a visual element to be displayed to the plurality of participants via respective graphical user interfaces (GUIs) of respective client devices associated with each participant, the visual element indicating that the speech of the first participant during the first portion of the virtual meeting is modified audio data generated by an AI model.

9. A method comprising:
generating first training data for training an artificial intelligence (AI) model, wherein generating the first training data comprises:
generating a first training input, the first training input comprising first training audio data associated with a suppressed tone of voice of a first participant;
generating a second training input, the second training input comprising second training audio data associated with a dynamic tone of voice of the first participant; and
providing the first training data to train the AI model on a set of training inputs comprising (i) the first training input and (ii) the second training input to generate a first training output that indicates, for a given audio data associated with a suppressed tone of voice of a respective participant, a first modified audio data associated with a first restored tone of voice of the respective participant.

10. The method of claim 9, wherein the first modified audio data reflects a transformation for one or more characteristics of the suppressed tone of voice of the respective participant.

11. The method of claim 10, wherein the one or more characteristics of the suppressed tone of voice comprise at least one of a volume characteristic, an intonation characteristic, an articulation characteristic, a speed characteristic, or a pronunciation characteristic.

12. The method of claim 9, further comprising:
generating second training data for training the AI model, wherein generating the second training data comprises:
prompting the respective participant to provide distorted audio data with the suppressed tone of voice of the respective participant;
prompting the respective participant to provide modified audio data with a regular tone of voice of the respective participant;
generating a third training input comprising the distorted audio data;
generating a fourth training input comprising the modified audio data, wherein the second training data comprises the third training data and the fourth training data; and
providing the second training data to train the AI model to generate a second training output that indicates, for a received audio data associated with the suppressed tone of voice of the respective participant, a second modified audio data associated with a second restored tone of voice of the respective participant.

13. The method of claim 12, wherein the AI model is further to generate a second training output that indicates a level of confidence that the second restored tone of voice matches the regular tone of voice of the respective participant.

14. A system comprising:
a memory;
one or more processing devices operatively coupled to the memory, the one or more processing devices to:
obtain distorted audio data captured at a client device of a first participant of a plurality of participants of a virtual meeting, wherein the distorted audio data is associated with a distorted tone of voice of the first participant;
generate, using a first trained artificial intelligence (AI) model, modified audio data that corresponds to the distorted audio data and is associated with a modified tone of voice of the first participant, the modified tone of voice reflecting one or more modifications to the distorted tone of voice; and
cause the modified audio data to represent speech of the first participant during a first portion of the virtual meeting between the plurality of participants.

15. The system of claim 14, wherein the distorted tone of voice is associated with first voice data of the first participant, the one or more processing devices further to:
remove, using a second trained AI model, (i) non-voice data and (ii) non-participant voice data from the distorted audio data, wherein the second trained AI model is trained on training voice data of the first participant to extract the first voice data of the first participant from the distorted audio data.

16. The system of claim 15, the one or more processing devices further to:
add, to the modified audio data generated by the first AI model, (i) the non-voice data of the distorted audio data and (ii) the non-participant voice data of the distorted audio data.

17. The system of claim 14, wherein the distorted tone of voice comprises one or more of a volume characteristic, an intonation characteristic, an articulation characteristic, a speed characteristic, or a pronunciation characteristic.

18. The system of claim 14, the one or more processing devices further to:
determine, using the first trained AI model, a level of confidence that the modified tone of voice matches a regular tone of voice of the first participant; and
cause a confidence indicator to be displayed to the first participant via a graphical user interface (GUI) of the client device, the confidence indicator being based on the determined level of confidence.

19. The system of claim 14, the one or more processing devices further to:
receive, through a graphical user interface (GUI) of the client device, user input to request that the distorted audio data represent speech of the first participant during a second portion of the virtual meeting; and
responsive to receiving the user input, cause the distorted audio data to represent the speech of the first participant during the second portion of the virtual meeting.

20. The system of claim 14, the one or more processing devices further to:
generate a first text transcript of the distorted audio data;
generate a second text transcript of the modified audio data; and
generate, based on the first text transcript and the second text transcript, a first participant text transcript for the first participant.
